(19) United States
(12) Patent Application Publication
(10) Pub. No.: US 2025/0274269 A1
(43) Pub. Date: Aug. 28, 2025

(54) INFORMATION MANAGEMENT METHOD AND INFORMATION MANAGEMENT SYSTEM

(71) Applicant: DENSO CORPORATION, Kariya-city (JP)

(72) Inventor: TATSUYA OKABE, Kariya-city (JP)

(21) Appl. No.: 19/208,187

(22) Filed: May 14, 2025

Related U.S. Application Data
(63) Continuation of application No. PCT/JP2023/036827, filed on Oct. 11, 2023.

(30) Foreign Application Priority Data
Nov. 17, 2022 (JP) 2022-184387

(51) Int. Cl. H04L 9/08; H04L 9/00; H04L 9/14; H04L 9/40

(52) U.S. Cl. CPC H04L 9/085; H04L 9/008; H04L 9/14; H04L 63/1416

(57) ABSTRACT

An information management method or an information management system prepares a secret key and a public key based on homomorphic encryption, shares the public key by a plurality of transactors, acquires acquisition encryption information encrypted using the public key by an upstream transactor that is a transactor in a previous process that supplies a delivery item, prepares generation encryption information obtained by encrypting, using the public key, item-related information, and sets a secure computation result to provision information provided to a downstream transactor in a next process that provides a shipping item.

### CROSS REFERENCE TO RELATED APPLICATIONS

The present application is a continuation application of International Patent Application No. PCT/JP2023/036827 filed on Oct. 11, 2023, which designated the U.S. and claims the benefit of priority from Japanese Patent Application No. 2022-184387 filed on Nov. 17, 2022. The entire disclosures of all of the above applications are incorporated herein by reference.

### TECHNICAL FIELD

This disclosure relates to information management technology.

### BACKGROUND

As a first comparative example, a supply chain management method for managing transaction records between each transactor in a supply chain that includes multiple transactors.

Further, as a second comparative example, an encryption system that performs homomorphic operations on encryption data encrypted by a user public key, and is capable of decrypting the result of the homomorphic operations using a master secret key.

### SUMMARY

An information management method or an information management system prepares a secret key and a public key based on homomorphic encryption, shares the public key by a plurality of transactors, acquires acquisition encryption information encrypted using the public key by an upstream transactor that is a transactor in a previous process that supplies a delivery item, prepares generation encryption information obtained by encrypting, using the public key, item-related information, and sets a secure computation result to provision information provided to a downstream transactor in a next process that provides a shipping item.

### BRIEF DESCRIPTION OF THE DRAWINGS

FIG. 1 is a diagram for illustrating operations of public and secret keys in a supply chain according to the first embodiment of the present disclosure.

FIG. 2 is a diagram showing an overview of the supply chain management system.

FIG. 3 is a flowchart showing details of a key sharing process in which the public key generated in an own process is provided to a transactor in a previous process.

FIG. 4 is a flowchart showing the details of the key sharing process in which a public key acquired from a subsequent process is provided to a transactor in the previous process.

FIG. 5 is a flowchart showing details of the secure computation process for calculating cumulative carbon emissions through secure computation.

FIG. 6 is a flowchart showing details of the decryption cumulation process of decrypting the cumulative carbon emissions up to the previous process and cumulating the carbon emissions in the own process.

FIG. 7 is a flowchart showing details of a process of registering information acquired from a transactor terminal in a management server process executed by an information management server.

FIG. 8 is a flowchart showing details of a process for providing register information to an information viewing server in the management server process.

FIG. 9 is a diagram showing details of a viewing server process executed by the information viewing server.

FIG. 10 is a diagram for illustrating operations of the public key and the secret key in the supply chain according to a second embodiment of the present disclosure.

FIG. 11 is a diagram showing an overview of the supply chain management system.

### DETAILED DESCRIPTION

Individual transactors constituting a supply chain generally prefer not to disclose information to external parties. Therefore, it may become difficult to acquire information about the entire supply chain by receiving information from all transactors. Therefore, the use of homomorphic operations, as employed in the encryption system of the second comparative example, was considered for acquiring information about the entire supply chain.

However, simply using the conventional encryption system of the second comparative example for supply chain information management makes it difficult to both avoid the disclosure of individual transactors' information to external parties and acquire information about the entire supply chain.

One example of the present disclosure provides an information management method and an information management system capable of acquiring information about the entire supply chain while keeping individual transactor information undisclosed.

Further, according to one example embodiment of the disclosure, an information management method is implemented by a computer for managing information associated with each of a plurality of transactors constituting a supply chain, and the method includes a process that is executed by at least one processor, and includes a step of: preparing a secret key and a public key based on homomorphic encryption; sharing the public key by the plurality of transactors; acquiring acquisition encryption information encrypted using the public key by an upstream transactor that is a transactor in a previous process that supplies a delivery item; preparing generation encryption information obtained by encrypting, using the public key, item-related information related to a process executed on the delivery item; and setting a secure computation result to provision information provided to a downstream transactor that is a transactor in a next process that provides a shipping item, wherein the secure computation result is obtained by secure computation using the acquisition encryption information and the generation encryption information.

Further, according to another example embodiment of the disclosure, an information management system manages information associated with each of a plurality of transactors constituting a supply chain (SC), and the system includes: a key generation unit configured to prepare a secret key and a public key based on homomorphic encryption, and cause the plurality of transactors to share the public key; an information acquisition unit configured to acquire acquisition encryption information encrypted using the public key by an upstream transactor that is a transactor in a previous process that supplies a delivery item; an information generation unit configured to prepare generation encryption information obtained by encrypting, using the public key, item-related information related to a process executed on the delivery item; and an information provision unit configured to set a secure computation result to provision information provided to a downstream transactor that is a transactor in a next process that provides a shipping item. The secure computation result is obtained by secure computation using the acquisition encryption information and the generation encryption information.

In these aspects, the acquisition encryption information, which is encrypted by the upstream transactor that provides the delivery item, and the generation encryption information, which is the item-related information associated with the process of the delivery item, are used in secure calculation. The secure computation result is then calculated. The result of the secure computation is then provided to the downstream transactor to which the shipping item is supplied. According to the above, even when the downstream transactor possesses the secret key sk, the acquisition encryption information and the generation encryption information, which were encrypted by the upstream transactor, are not provided to the downstream transactor. Therefore, the item-related information of the upstream transactor and the item-related information of the current transactor are not disclosed to the downstream transactor. In addition, as the transaction progresses, generation encryption information of each transactor is added to the secure computation result. Therefore, the holder of the secret key is possible to acquire information about the entire supply chain by decrypting the cumulative secure computation result.

Thus, while keeping the information of individual transactors undisclosed, it becomes possible to acquire information about the entire supply chain.

Hereinafter, multiple embodiments of the present disclosure will be described with reference to the drawings. The same reference signs are assigned to corresponding components in the embodiments, and thus duplicate descriptions may be omitted. In each of the embodiments, when only a part of the configuration is described, the remaining parts of the configuration may adopt corresponding parts of other embodiments. In addition to the combinations of configurations specifically shown in various embodiments, the configurations of various embodiments can be partly combined even if not explicitly suggested, unless such combinations are contradictory. Unspecified combinations of the configurations described in the multiple embodiments and the modification examples are considered to be also disclosed in the following description.

### First Embodiment

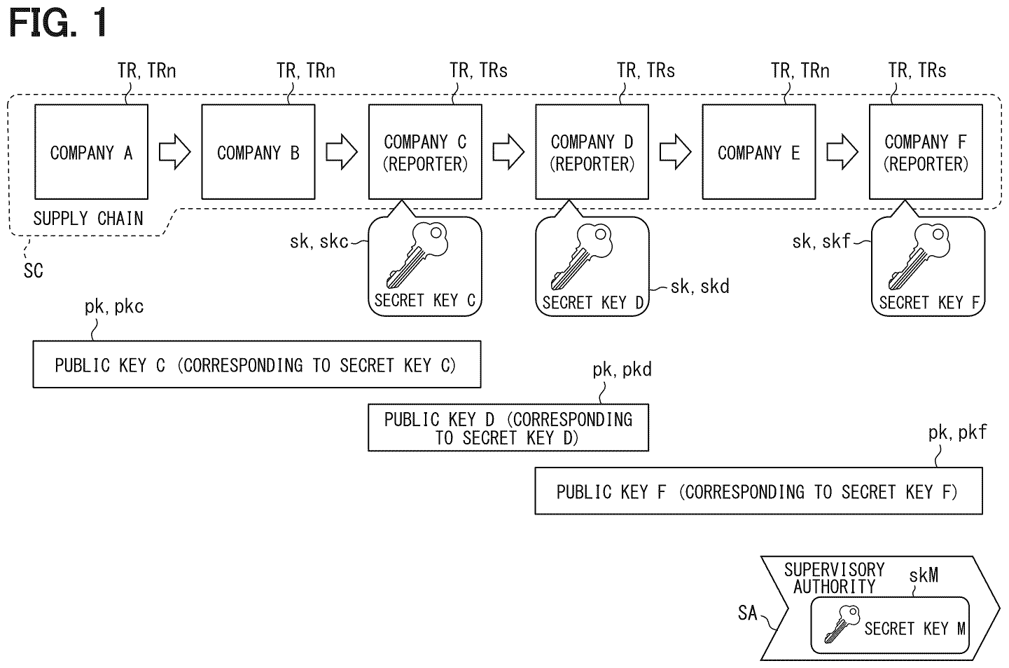

A supply chain SC shown in FIG. 1 is a network of transactors TR for delivering industrial products, agricultural products, and marine products to end users. The supply chain SC includes a large number of transactors TR (see companies A to F in FIG. 1). The final product supplied by the supply chain SC may be various articles, such as automobiles, batteries, semiconductors, fresh produce, seafood, foods, flowers, pharmaceuticals, and chemicals.

A supply chain management system according to a first embodiment of the present disclosure manages transaction records of items transacted between transactors TR in the supply chain SC as information associated with each transactor TR. The transaction record is history information that implements traceability of an item transacted between transactors TR, and includes a large number of pieces of information indicating a time, a place, and the like when the transaction occurs.

In addition to the transaction records, the supply chain management system further manages item-related information associated with the items subject to the transactions. For example, information related to raw materials, information related to processing and assembly, and information related to distribution are managed as item-related information. Furthermore, the supply chain management system collects and accumulates information related to greenhouse gas emissions (hereinafter referred to as carbon release amounts) emitted during each process of the manufacturing and distribution of items as one of the item-related information.

The supply chain management system acquires the value acquired by summing carbon release amounts emitted by each transactor TR and can present it as a carbon footprint to end users, a supervisory authority SA, and the like. The carbon footprint may include the carbon release amounts from processes such as mining and recycling of raw materials for the items, as well as the carbon release amounts from processes related to the disposal of the items, such as incineration and landfill. Furthermore, the carbon footprint may also include the carbon release amounts from a transportation process, as well as the carbon release amounts from sources not directly involved in manufacturing, such as offices.

Greenhouse gases for which emissions are recorded may include only carbon dioxide, or may appropriately include greenhouse gases other than carbon dioxide, specifically methane, nitrous oxide, hydrofluorocarbons, perfluorocarbons, sulfur hexafluoride, and the like. In this case, the emission of the greenhouse gas other than carbon dioxide is converted into an emission amount of carbon dioxide and is calculated into the carbon footprint to be displayed.

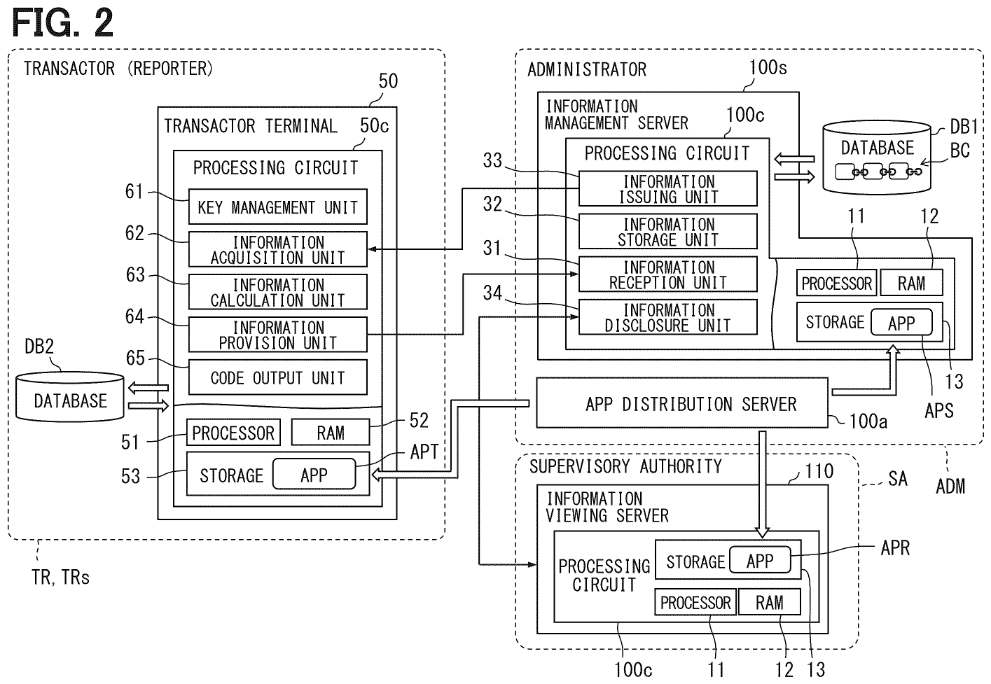

Here, the carbon release amounts are often trade secrets of each transactor TR. This is because the carbon release amounts may allow for the inference of takt time and manufacturing methods related to production. Therefore, many companies are reluctant to disclose their carbon release amounts to other transactors TR and the like. Against this background, the supply chain management system accumulates the carbon release amounts of each transactor TR without disclosing them, and only acquires the carbon footprint of the final product. Hereinafter, the details of the supply chain management system will be described with reference to FIGS. 1 and 2.

The supply chain management system includes numerous transactor terminals 50, an information management server 100s, an application distribution server 100a, and an information viewing server 110, and the like. Each element constituting the supply chain management system is connected to a network as a single node and can communicate with each other.

### Transactor and Transactor Terminal

The transactor terminal 50 is an information processing device operated by individual transactors TR. For example, smartphones, tablet devices, and personal computers can be used as the transactor terminal 50. The transactor terminals 50 are respectively associated with individual companies A to F (see FIG. 1). The transactor terminals 50 are used by each transactor TR to collect and store transaction records and item-related information. The transactor terminals 50 stores, as transaction records, delivery information, such as information indicating a transactor TR from which raw materials, parts, and the like were purchased, delivery information indicating the acquisition time and the like, shipping information such as information indicating a shipping destination that is the transactor TR, the shipped time, and the like. Furthermore, the transactor terminals 50 stores, as record information, at least item-related information and carbon emissions and the like.

The transactor terminal 50 mainly includes a processing circuit 50c. The processing circuit 50c includes a processor 51, RAM (Random Access Memory) 52, a storage 53, input-output interfaces, and a bus that connects these components, and functions as a computer that executes a calculation process. The processor 51 is hardware for calculation processing coupled with the RAM 52. The storage 53 stores an application program (information management application APT) for executing the information management method according to the present disclosure on the processing circuit 50c. A display, code reader (or camera), and printer are electrically connected to the input-output interface. The display, code reader, and printer may be integrally configured with the transactor terminal 50, or they may be electrically connected to the transactor terminal 50 via wired or wireless connections.

The transactor terminal 50 has functional units such as a key management unit 61, an information acquisition unit 62, an information calculation unit 63, an information provision unit 64, and a code output unit 65, which are implemented by the processor 51 executing the information management application APT stored in the storage 53.

The key management unit 61 manages the secret key sk and the public key pk based on homomorphic encryption. Generally, a transactor TR often has only a public key pk, but a transactor TR that mainly manages the carbon release amount may have the secret key sk. The secret key sk and the public key pk are used for encrypting and decrypting item-related information, which corresponds to trade secrets, when providing this information to the transactor terminals 50 of other transactors TR. The homomorphic encryption is an encryption method that allows data to be processed in its encrypted form without needing to decrypt the encrypted data. The key management unit 61 utilizes, for example, fully homomorphic encryption (FHE) and the like as one type of homomorphic encryption. The fully homomorphic encryption enables operations such as addition, subtraction, multiplication, and division to be performed on encrypted data without decrypting it. Instead of the fully homomorphic encryption, multiplicative homomorphic encryption methods like RSA encryption and ElGamal encryption, as well as additive homomorphic encryption methods like Goldwasser-Micali encryption and Paillier encryption, can be utilized depending on a processing content of secure computation described later.

To further describe the secure computation using the homomorphic encryption, the key management unit 61 generates the shared public key pk and the secret key sk having decryption authority using the key generation function KeyGen. Then, the message space is defined as M, the cipher space is defined as C, the probabilistic encryption function is defined as Enc, and the deterministic decryption function is defined as Dec. For a message m ∈M, encryption is defined as c←Enc(m,pk) and decryption is defined as m←Dec(c,sk). Furthermore, the state capable of processing data in an encrypted state means that, for messages m1, m2∈M, there exists an operator+in the message space M (right side) and an operator (the symbol “+ on a circle” above, exclusive OR) in the encryption space C (left side) as shown in the following first mathematical equation.

$$Dec ( Enc ( m 1 , pk ) ⊕ Enc ( m 2 , pk ) , sk ) = m 1 + m 2 \qquad ( First Mathematical Equation )$$

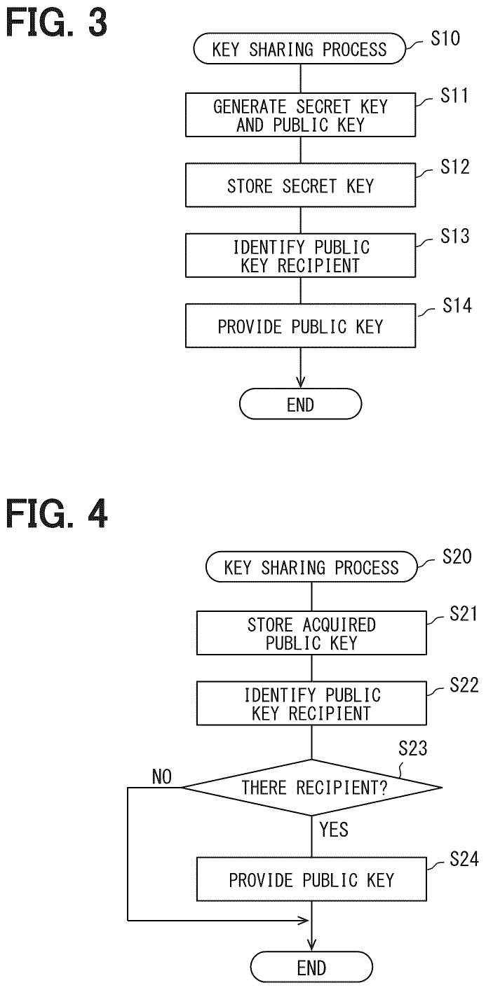

The key management unit 61 executes a key sharing process (see FIGS. 3 and 4) to share the public key pk among multiple transactors TR. The content of the key sharing process is modified according to the attributes of the transactor TR operating the transactor terminal 50. Specifically, among the numerous transactors TR, there are reporters TRs that are obligated to report the item-related information (carbon footprint) to the supervisory authority SA overseeing the supply chain SC, and non-reporters TRn that do not have reporting obligations. The transactor TR that supplies the final product, the transactor TR that supplies specific finished products to the supply chain SC, and the like are pre-selected as the reporter TRs.

The key management unit 61 of the transactor terminal 50 operated by reporters TRs (see companies C, D, and F in FIG. 1) performs a key sharing process (FIG. 3, S10) to share the generated public key pk with the upstream transactors TR (previous transactors). In the key sharing process, the key management unit 61 prepares a pair of secret key sk and public key pk based on fully homomorphic encryption by generating them using the key generation function described above (S11). The key management unit 61 securely stores the generated secret key sk (see secret key Cskc, secret key Dskd, secret key Fskf in FIG. 1) to prevent any external leakage (S12).

The key management unit 61 identifies the recipients of the generated public key pk (see public key Cpkc, public key Dpkd, public key Fpkf in FIG. 1) (S13). The recipients of the public key pk are determined based on the connection manner of the transactors TR within the supply chain SC. Specifically, the upstream transactors, which are the suppliers of the items (hereinafter referred to as delivery items) delivered (supplied) to the company, are selected as the recipients of the public key pk. When multiple transactors TR deliver items to the company, multiple upstream transactors are designated as recipients of the public key pk. The key management unit 61 provides the public key pk to the identified recipients (S14). The key management unit 61 shares the public key pk with the key management unit 61 of the transactor terminal 50 associated with the upstream transactors via secure communication over the network.

The key management unit 61 of the transactor terminal 50, operated by non-reporting transactors TRn (see FIG. 1, companies A, B, and E), executes a key sharing process (FIG. 4, S20) to share the public key pk acquired from the downstream transactors (subsequent transactors) with the upstream transactors. The key management unit 61 stores the public key pk acquired from the downstream transactors (S21). The key management unit 61 identifies the recipients of the acquired public key pk (S22). In this case, similar to the above-described process (see FIG. 3, S13), one or more upstream transactors, which are the suppliers of the delivery items, are selected as the recipients of the public key pk.

The key management unit 61 determines whether there are recipients for the public key pk (S23). When the company is the transactor TR at the starting point of the supply chain SC and there are no recipients for the public key pk (S23: NO), the key management unit 61 ends the key sharing process. On the other hand, when there are upstream transactors to which the key can be provided (S23: YES), the key management unit 61 provides the acquired public key pk from the downstream transactors to the identified recipients via secure communication (S24).

By executing the above key sharing process at each transactor terminal 50, the public key pk is delivered in a direction opposite to the item (upstream direction) along the supply chain SC. As a result, the unique public key pk is shared among multiple related transactors TR before the accumulation of item-related information starts.

As a specific example, in the supply chain SC including companies A to F (see FIG. 1), the public key Cpkc, public key Dpkd, and public key Fpkf are shared among the related companies. That is, in the company C, a secret key Cskc is generated, and a corresponding public key Cpkc is generated. The public key Cpkc is shared among the companies A to C. Similarly, in the company D, a secret key Dskd is generated, and a corresponding public key Dpkd is generated. The public key Dpkd is shared between the companies C and D. Furthermore, in the company F, a secret key Fskf is generated, and a corresponding public key Fpkf is generated. The public key Fpkf is shared among the companies D to F. Additionally, the sharing of public keys pk through each key sharing process may be performed via the information management server 100s.

The information acquisition unit 62 acquires the identification information of the delivery items read by the code reader. As the identification information of the items, at least one of a unique identification ID (hereinafter referred to as UID) issued by the information management server 100s, or a hash value generated from transaction records and item-related information is used. The identification information containing at least one of the UID and the hash value is recorded in a one-dimensional code or two-dimensional code (for example, a QR code, registered trademark) attached to the delivery items, which can be read by a code reader or the like.

The information acquisition unit 62 acquires the transaction records and item-related information of the items. The item-related information includes, the above-described information regarding the amount of carbon release in addition to information related to the processing (for example, machining, assembly, transportation, and storage) performed by the transactor TR on the delivery items. The information acquisition unit 62 may automatically acquire transaction records and item-related information from other server devices installed at an operating base of the transactor TR, or may acquire manually entered data as transaction records and item-related information according to predefined management processes.

The information acquisition unit 62 acquires the UID to be attached to the items shipped (hereinafter referred to as shipping item) from the company through reception from the information management server 100s. In the form that uses a hash value for item identification, the information acquisition unit 62 acquires the hash value generated by the information calculation unit 63. The information acquisition unit 62 stores the transaction records and item-related information in the user database DB2, linked with the respective UIDs (or hash values) of the delivery items and shipping items. The information acquisition unit 62 extracts transaction records and item-related information associated with the UID (or hash value) from the data accumulated in the user database DB2 by using the UID or hash value as the search key. The user database DB2 may be a local storage device installed at the location of the transactor TR, or it may be cloud-based storage.

The information calculation unit 63 performs various calculations related to the transaction records and item-related information. The information calculation unit 63 generates the above-described hash value by processing the transaction records and item-related information associated with the item through a predetermined hash function. Furthermore, the information calculation unit 63 executes a process of encrypting the item-related information using the public key pk and the process of performing secure computation on the encrypted information.

The information provision unit 64 provides the information collected at the transactor terminal 50 to the information management server 100s. The information provision unit 64 links the hash value generated by the information calculation unit 63 to the UID, and transmits it to the information management server 100s (information reception unit 31 described later). Incidentally, the hash value may be generated by the information management server 100s and issued to the transactor terminal 50 in the same manner as the UID. In such an embodiment, the information provision unit 64 transmits, to the information management server 100s, the information that does not correspond to trade secrets among the transaction records and item-related information acquired by the information acquisition unit 62. The information management server 100s generates a hash value based on the received information and issues the generated hash value to the information acquisition unit 62.

The code output unit 65 is connected to a printer. The code output unit 65 outputs a label with a printed two-dimensional code or similar to the printer. The two-dimensional code records the UID or hash value issued by the information management server 100s (information issuing unit 33 described later). The label is attached to the shipping item and circulates to the next process transactor TR along with the shipping item. In addition, the two-dimensional code may be directly laser-engraved or printed onto the item. In this case, a laser marker or inkjet printer can be used as the output device instead of a printer.

### Secure Computation Process and Decryption Summation Process

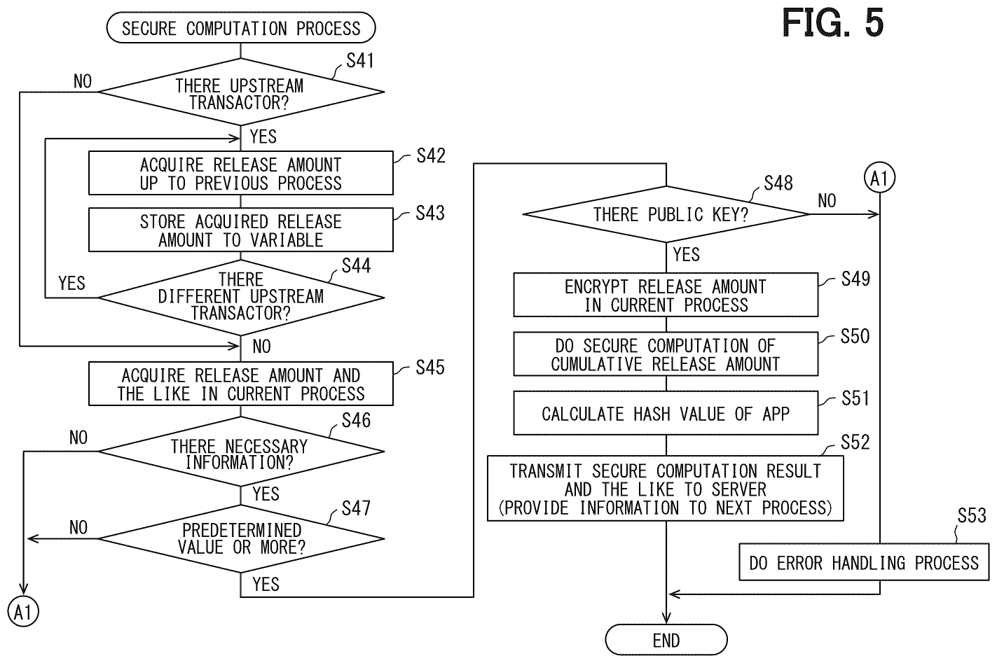

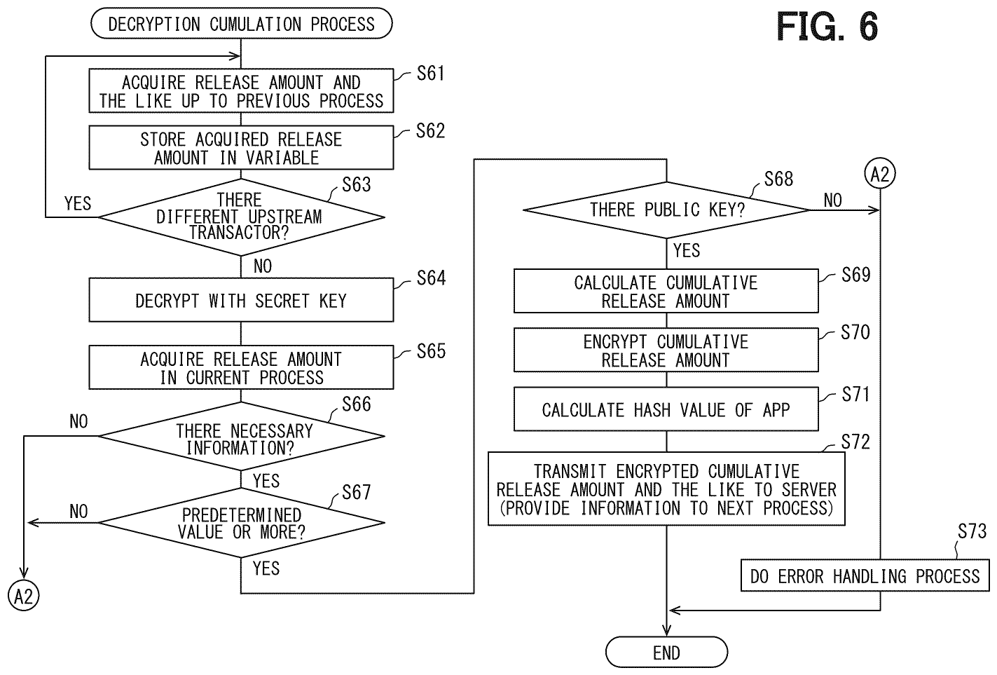

The information acquisition unit 62, the information calculation unit 63, and the information provision unit 64 described so far execute a secure computation process (see FIG. 5) or decryption summation process (see FIG. 6). The secure computation process and decryption summation process are continuously and repeatedly executed by the transactor terminal 50. The secure computation process is executed by the transactor terminal 50 operated by the non-reporters TRn (see FIG. 1, companies A, B, and E). In the secure computation process, the carbon release amounts are summed while remaining encrypted. On the other hand, the decryption summation process is executed by the transactor terminal 50 operated by the reporters TRs (see FIG. 1, companies C, D, and F). In the decryption summation process, the carbon release amounts are summed, and the switching of the public key pk used for encryption is performed.

In the secure computation process (see FIG. 5), the information acquisition unit 62 determines the presence of the upstream transactor (S41). When the upstream transactor exists (S41: YES), it acquires information related to the carbon release amount up to the previous process (S42). Specifically, the information acquisition unit 62 acquires the information of the carbon release amount (hereinafter referred to as “encrypted different company release amount”) encrypted using the public key pk by the preceding transactor providing the delivery item. Additionally, the information acquisition unit 62 also acquires information such as the above-described UID or hash value that identifies the delivery item. The information acquisition unit 62 stores the acquired information of the encrypted different company release amount into a variable (S43). The information acquisition unit 62 determines the presence of other upstream transactors (S44). When other upstream transactors exist (S44: YES), it repeats the acquisition and storage of the encrypted different company release amount and other related information.

Here, the information acquisition unit 62 acquires the encrypted different company release amount by receiving it from the information management server 100s. Specifically, the information acquisition unit 62 acquires the encrypted different company release amount associated with the delivery item from the information management server 100s (information issuing unit 33, described later) by making a request to the information management server 100s using the UID or hash value of the delivery item. When multiple delivery items are used in the shipping items of the own company, the information acquisition unit 62 acquires multiple encrypted different company release amounts from the information management server 100s. Additionally, the information acquisition unit 62 may directly acquire the encrypted different company release amount from the transactor terminal 50 associated with the upstream transactor.

When the information acquisition unit 62 has acquired the encrypted different company release amounts from all upstream transactors (S44: NO), it acquires information indicating the carbon release amount in the own company process (hereinafter referred to as “own process”) (S45). The information acquisition unit 62 determines whether the encrypted different company release amounts, the carbon release amount of the own process, and all other necessary input items have been acquired (S46). When the necessary information has not been acquired (S46: NO), the corresponding error handling process is executed (S53). On the other hand, when all the necessary information has been acquired (S46: YES), the information acquisition unit 62 determines whether the carbon release amount of the own process is equal to or greater than a predetermined value set in advance (S47). The predetermined value is determined, for example, by the information management server 100s (administrator ADM). When the carbon release amount of the own process is less than the predetermined value (S47: NO), the corresponding error handling is executed (S53).

As described above, the information acquisition unit 62 verifies whether the calculation of the carbon release amount for the own process has not been omitted (S46), and whether the carbon release amount for the own process has not been underestimated (S47). As a result, the information acquisition unit 62 detects the occurrence of such improper processing when the carbon release amount in the own process is processed through secure computation.

When the carbon release amount in the own process is equal to or greater than the predetermined value (S47: YES), the information calculation unit 63 determines the presence or absence of the encryption public key pk (see FIG. 4, S21) (S48). When the encryption public key pk is not present (S48: NO), the corresponding error handling is executed (S53). On the other hand, when the encryption public key pk is present (S48: YES), the information calculation unit 63 encrypts the carbon release amount in the own process using the stored public key pk and prepares the encrypted own release amount (S49). Furthermore, the information calculation unit 63 uses secure computation with one or more encrypted different company release amounts and the encrypted own release amount to add the carbon release amount in the own process to the carbon release amount up to the previous process while maintaining the encrypted state (S50).

The information calculation unit 63 calculates the cumulative carbon release amount (hereinafter referred to as the encryption cumulative release amount) through secure computation. At this time, according to the type of process conducted within the company, such as additional processes, integration processes, and branching processes, the information calculation unit 63 can perform secure computations such as multiplication and division, in addition to simple addition. For example, when the encrypted different company release amount corresponds to the carbon release amount for one lot, the information calculation unit 63 can divide the encrypted different company release amount by the number of items contained in one lot to calculate the carbon release amount for a single item.

The information calculation unit 63 calculates the hash value of the information management application APT (S51). The information provision unit 64 uses the encryption cumulative release amount acquired as a result of secure computation as the information provided to the downstream transactor, and uploads it to the information management server 100s associated with the UID or hash value of the shipping item (S52). Specifically, the information provision unit 64 transmits a data registration request to the information management server 100s. The information provision unit 64 transmits, to the information management server 100s for registration, data including information related to the previous process, input items entered in the own process, the encrypted own company release amount, the encryption cumulative release amount, the hash value of the information management application APT, the public key pk used for encryption, and the like.

The information related to the previous process includes, for example, the UID or hash value read from the two-dimensional code of the delivery items. Additionally, when the transactor TR, which is the starting point of the supply chain SC, executes the secure computation process, there are no upstream transactors. Therefore, the encrypted own company release amount can be uploaded to the information management server 100s as the encryption cumulative release amount (provision information). The encryption cumulative release amount or encrypted own company release amount uploaded to the information management server 100s is provided to the information acquisition unit 62 as the encrypted different company release amount, based on the provision request from the transactor terminal 50, for use in the secure computation process or decryption summation process executed by downstream transactors.

In the decryption summation process (see FIG. 6), the information acquisition unit 62 acquires the encrypted different company release amount, which indicates the carbon release amount up to the previous process, and information such as the UID or hash value that identifies the delivery item (S61). The information acquisition unit 62 stores the encrypted different company release amount in a variable (S62). The information acquisition unit 62 determines whether there are other upstream transactors (S63). When other upstream transactors exist (S63: YES), it repeats the process of acquiring and storing the encrypted different company release amounts and the like.

Once the encrypted different company release amounts from all upstream transactors have been acquired (S63: NO), the information calculation unit 63 decrypts the acquired encrypted different company release amounts using the stored secret key sk (see FIG. 3, S12). As a result, the information calculation unit 63 acquires (prepares) the cleartext carbon release amounts up to the previous process (hereinafter referred to as cleartext different company release amounts) (S64). Furthermore, the information acquisition unit 62 acquires information indicating the carbon release amount in the own process (S65).

The information acquisition unit 62 uses a method similar to the secure computation process (see FIG. 5) to verify whether the calculation of the carbon release amount for the own process has not been omitted (S66) and whether the carbon release amount for the own process has not been underestimated (S67). Based on the above, the information acquisition unit 62 detects any occurrence of unauthorized process in the secure computation that cumulates the carbon release amounts in the own process.

The information acquisition unit 62 determines whether the encrypted different company release amounts, the carbon release amounts for the own process, and all other necessary input items have been acquired (S66). When the necessary information has not been acquired (S66: NO), the corresponding error handling process is executed (S73). On the other hand, when all the necessary information has been acquired (S66: YES), the information acquisition unit 62 determines whether the cumulative carbon release amount up to the previous process, and determines whether the carbon release amount for the own process are equal to or greater than a predetermined value (S67). Each predetermined value is determined, for example, by the information management server 100s (administrator ADM). When at least one of the carbon release amounts is less than the predetermined value (S67: NO), the corresponding abnormality process is executed (S73). In contrast, when each of the carbon release amounts is equal to or greater than the predetermined value (S67: YES), it is determined whether the public key pk for encryption (see FIG. 4, S21) is present (S68). When the public key pk for encryption is not present (S68: NO), the corresponding error handling process is executed (S73).

When the public key pk for encryption is present (S68: YES), the information calculation unit 63 cumulates the carbon release amount of the own process and the carbon release amount (hereinafter referred to as a cleartext cumulative release amount) up to the previous process, and calculates the cumulative carbon release amount up to the own process (S69). The information calculation unit 63 encrypts the cleartext cumulative release amount using the stored public key pk and calculates the encryption cumulative release amount (S70).

The information calculation unit 63 calculates the hash value of the information management application APT (S71). The information provision unit 64 includes the encryption cumulative release amount in the information provided to the downstream transactors and uploads it to the information management server 100s, associated with the UID or hash value of the shipping item (S72). In the decryption and summation process, the information provision unit 64 transmits a data registration request to the information management server 100s. Then, information related to the previous process, the input items entered in the own process, the encryption cumulative release amount, the hash value of the information management application APT, and the public key pk used for encryption are transmitted to the information management server 100s. The information provision unit 64 may generate an encrypted own company release amount by encrypting the carbon release amount of the own process and further transmit the generated encrypted own company release amount to the information management server 100s.

By executing the above secure computation process and decryption summation process using each transactor terminal 50, the carbon release amounts for each transactor TR are summed. As a result, the carbon footprint associated with the final product supplied by the supply chain SC can be acquired by the final product transactor TR and the supervisory authority SA.

As a specific example, in the supply chain SC including companies A to F (refer to FIG. 1), the carbon release amount acquired by the company A is encrypted with the public key pkc and provided to company B. Next, the carbon release amount acquired by the company B is encrypted with the public key pkc, added to the encrypted carbon release amount (encrypted different company release amount) acquired from the company A, and provided to the company C.

Furthermore, the carbon release amount acquired by company C is added to the carbon release amount up to the company B (cleartext different company release amount) decrypted with the secret key skc. The combined carbon release amount is encrypted with the public key pkd and provided to the company D. Next, the carbon release amount acquired by company D is added to the carbon release amount up to the company C, which is decrypted using the secret key skd. The combined carbon release amount is encrypted with the public key pkf and provided to the company E.

Then, the carbon release amount of the company E is encrypted with the public key pkf, added to the encrypted carbon release amount acquired from the company D, and provided to the company F. Next, the carbon release amount of company F is added to the carbon release amount up to company E, which is decrypted using the secret key skf. As a result, the carbon footprint of the final product provided by company F can be acquired.

### Administrator and Information Management Server

The information management server 100s and the application distribution server 100a are server devices operated by the administrator ADM of the supply chain SC. The administrator ADM is, for example, an agent entrusted with management tasks by the provider of the final product (finished product manufacturer) supplied by the supply chain SC. The administrator ADM may also be an agency entrusted with management and auditing tasks by the supervisory authority SA, which has supervisory authority over the category to which the final product belongs. The information management server 100s and the application distribution server 100a may be an on-premises configuration physically managed by the administrator ADM or a system supplier, or they may be a virtual server configuration provided on the cloud.

The information management server 100s is an information processing device mainly including a processing circuit 100c. The processing circuit 100c includes a processor 11, a RAM 12, a storage 13, an input-output interface, and a bus connecting these components, and functions as a computer that executes a calculation process. The processor 11 is hardware for performing arithmetic processing combined with RAM 12 and executes programs stored in the storage 13.

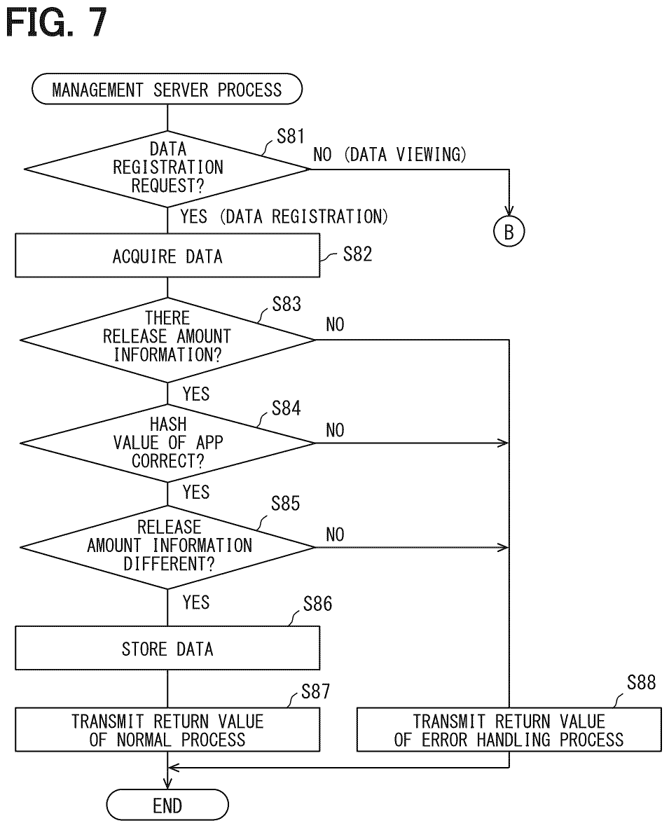

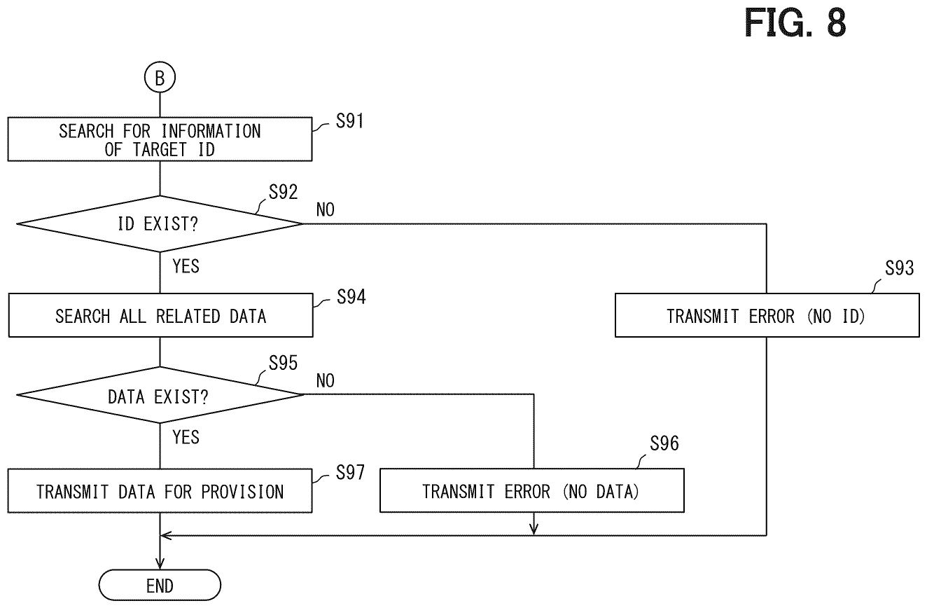

The information management server 100s is an information management device for the administrator ADM that manages transaction records and item-related information. The storage 13 stores an application program (information management app APS) for causing the processing circuit 100c to implement the information management method according to the present disclosure. The information management server 100s has functional units such as an information reception unit 31, an information storage unit 32, an information issuing unit 33, and an information disclosure unit 34, through execution of the information management application APS by the processor 11. The information management server 100s continuously and repeatedly executes the management server process, described later (see FIGS. 7 and 8), through the cooperation of each functional unit.

The information reception unit 31 receives registration requests for data transmitted from the transactor terminal 50 and viewing requests for data transmitted from the information viewing server 110. When the information reception unit 31 receives a registration request for data, it acquires transaction records and item-related information transmitted from the transactor terminal 50 through reception.

Based on the registration request for data, the information storage unit 32 stores the transaction records and item-related information acquired by the information reception unit 31 in the administrator database DB1, linking them with a UID or hash value. The administrator database DB1 stores storing target data, such as transaction records and item-related information, in a substantially tamper-impossible state using blockchain BC technology. The administrator database DB1 treats the acquired storing-target data as a transaction and stores it in a block of the private blockchain BC. The administrator database DB1 hashes the information stored in one block and stores it in the next block. Thereby, it becomes difficult to tamper with the storing-target data stored in each block. The administrator database DB1 may store the hash values generated from the storing-target data in the blocks of a consortium-type or public-type blockchain BC. Thereby, it may be substantially impossible to tamper with the storing-target data.

The information issuing unit 33 issues a UID or hash value for identifying the item to each transactor TR. The information issuing unit 33 provides the encryption cumulative release amount up to the previous process to the information acquisition unit 62 of the transactor terminal 50, which executes the secure computation process (see FIG. 5) or decryption summation process (see FIG. 6). The information issuing unit 33 transmits a return value indicating the success or failure of the processing based on the data registration request to the transactor terminal 50. The information issuing unit 33 transmits a return value indicating the success or failure of the processing based on the data viewing request to the information viewing server 110.

The information disclosure unit 34 extracts information associated with the UID or hash value targeted for viewing from among the numerous pieces of information stored in the administrator database DB1, based on the data viewing request. The information disclosure unit 34 generates provision data based on the information extracted from the administrator database DB1 and provides the generated provision data to the information viewing server 110, which is the request source.

The application distribution server 100a functions as a server device that distributes application programs (hereinafter referred to as traceability apps) related to traceability management. The application distribution server 100a distributes information management apps APS and APT, as well as information viewing app APR, as the traceability apps. The application distribution server 100a may also distribute the above-described key generation function KeyGen. The information management app APS is a traceability app intended for administrators (ADM). The information management app APS is distributed to the information management server 100s and installed on the information management server 100s. The information management application APT is a traceability app for transactors TR. The information management application APT is distributed to the transactor terminal 50 and installed on the processing circuit 50c. The information viewing app APR is a traceability app for supervisory authority SAs. The information viewing app APR is distributed to the information viewing server 110 and installed on the processing circuit 100c of the information viewing server 110. Each app, APS, APT, APR, and the key generation function KeyGen, is updated periodically for enabling the maintenance of security in traceability management.

Additionally, the application distribution server 100a may be operated by the platform provider of the operating system that runs the transactor terminal 50 or each of the servers 100s and 110. In such a configuration, the latest application programs are provided by the administrator ADM to the platform provider and are distributed from the server device operated by the platform provider to the transactor terminal 50 or each of the servers 100s and 110.

### Supervisory Authority and Information Viewing Server

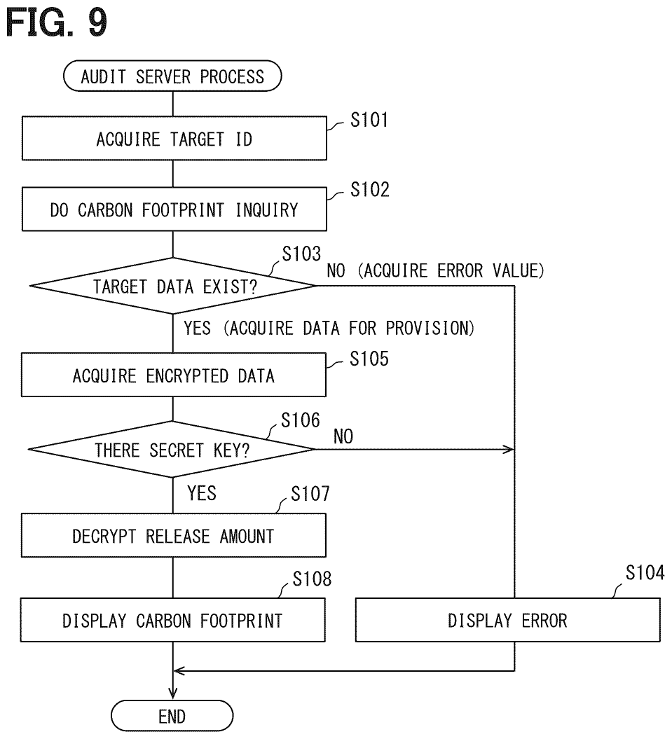

The information viewing server 110 is a server device operated by the supervisory authority SA. The information viewing server 110 may be an on-premises configuration physically managed by the supervisory authority SA, or it may be a virtual server configuration established on the cloud. The information viewing server 110 is an information processing device mainly including a processing circuit 100c. The storage 53 stores an application program (information viewing application APR) for executing the information management method according to the present disclosure on the processing circuit 100c. A display and input devices and the like are connected to the input-output interface of the processing circuit 100c. The information viewing server 110 executes the information viewing application APR stored in the storage 13 by the processor 11, thereby continuously and repeatedly executing an audit server process (see FIG. 9) described later.

The information viewing server 110 holds a master secret key skM (secret key M in FIG. 1). The master secret key skM is a decryption key distinct from the secret key sk held by the transactor TR. The master secret key skM is a superior version of the secret Fskf held by the transactor TR (see company F in FIG. 1) that supplies the final product, and can at least decrypt data encrypted with the public key Fpkf. The master secret key skM may also be capable of further decrypting data encrypted with the public key Cpkc or the public key Dpkd. The information viewing server 110 may hold a different master secret key skM that is capable of decrypting data encrypted with the public key Cpkc or the public key Dpkd.

### Management Server Process and Audit Server Process

Next, the details of the management server process executed by the information management server 100s (see FIGS. 7 and 8) and the audit server process executed by the information viewing server 110 (see FIG. 9) will be described.

In the management server process (see FIG. 7), the information reception unit 31 receives requests from the transactor terminal 50 and the information viewing server 110. The information reception unit 31 determines the content of the received request (S81). When a data registration request from the transactor terminal 50 is received (S81: YES), the information reception unit 31 acquires the transaction record and item-related information transmitted from the transactor terminal 50 by receiving them (S82). Specifically, the information reception unit 31 acquires information related to the previous process (delivery items) and the UID or hash value associated with the shipping items as transaction records (see S52 in FIGS. 5 and S72 in FIG. 6). Additionally, the information reception unit 31 acquires items entered in the current process, encrypted carbon release amounts, the hash value of the information management application APT, and the public key pk, and the like as item-related information.

The information reception unit 31 detects the occurrence of unauthorized process when the unauthorized process is executed during the secure computation. The information reception unit 31 determines the validity of the encrypted carbon release amounts without decrypting them. The information reception unit 31 determines whether the information on the encrypted individual release amount and the encryption cumulative release amount has been acquired (S83). When the necessary information has been acquired (S83: YES), the information reception unit 31 further determines whether the hash value of the information management application APT matches the hash value of the valid released application (S84). That is, based on the comparison of hash values, the information reception unit 31 determines whether the correct information management application APT is operating on the transactor terminal 50.

When the acquired hash value matches the legitimate value (S84: YES), the information reception unit 31 compares the encryption cumulative release amount acquired from the transactor terminal 50 in the previous process with the encryption cumulative release amount acquired from the transactor terminal 50 in the current process (S85). When the two encryption cumulative release amounts are the same (S85: NO), the information reception unit 31 assumes that the addition of the carbon release in the current process has been omitted. On the other hand, when the two encryption cumulative release amounts are different (S85: YES), the information storage unit 32 assumes that the accumulation has been correctly performed, and stores the acquired transaction records and item-related information in the administrator database DB1, associated with the UID or hash value (S86). In this case, the information issuing unit 33 transmit a return value indicating normal processing to the transactor terminal 50 (S87). In contrast, in a case where there is insufficient information (S83: NO), when the hash value does not match the correct value (S84: NO), or when the encryption cumulative release amount has not changed (S85: NO), the information issuing unit 33 transmits a return value indicating the error handling process to the transactor terminal 50 (S88).

In the management server process (refer to FIG. 8), when the information reception unit 31 receives a data viewing request from the information viewing server 110 (S81: NO), the information disclosure unit 34 generates provision data. Specifically, the information disclosure unit 34 searches for the target ID acquired from the information viewing server 110 along with the data viewing request, within the information stored in the administrator database DB1 (S91), and determines whether the target ID exists within the accumulated data (S92). When the target ID does not exist (S92: NO), the information disclosure unit 34 transmits an error value indicating the non-existence of the target ID to the requesting information viewing server 110 (S93).

When the target ID exists (S92: YES), the information disclosure unit 34 searches for all data related to the target ID (such as transaction records) (S94). When no data related to the target ID exists in the information stored in the administrator database DB1 (S94: NO), the information disclosure unit 34 transmits an error value indicating the non-existence of the data to the requesting information viewing server 110 (S96). On the other hand, when data related to the target ID exists (S94: YES), the information disclosure unit 34 transmits the provision data generated from the searched data to the requesting information viewing server 110 (S97). The information disclosure unit 34 provides the information viewing server 110 with the provision data that includes at least the encryption cumulative release amount and information indicating the public key pk used to encrypt the encryption cumulative release amount.

In the audit server process (see FIG. 9), the information viewing server 110 acquires, as the above-described target ID, the identification information (UID or hash value) of the final product or specific finished product for which the carbon footprint is to be viewed (S101). The target ID may be read from a two-dimensional code using a camera or code reader, or it may be loaded from data prepared in advance. The information viewing server 110 makes an inquiry about the carbon footprint by transmitting a data viewing request, along with the read target ID, to the information management server 100s (S102).

The information viewing server 110 determines whether data associated with the target ID exists (S103). When a value indicating the occurrence of an error (see S93 or S96 in FIG. 8) is received, the information viewing server 110 determines that no data associated with the target ID exists (S103: NO) and displays an error using a display or the like (S104). On the other hand, when the provision data (see S97 in FIG. 8) is returned, the information viewing server 110 determines that data associated with the target ID exists (S103: YES). In this case, the information viewing server 110 acquires the encryption cumulative release amount provided as the provision data (S105).

The information viewing server 110 determines whether it holds the secret key sk (master secret key skM) capable of decrypting the acquired encryption cumulative release amount (S106). When the secret key sk is not held (S106: NO), the information viewing server 110 displays an error message using a display or the like (S104). On the other hand, when the secret key sk is held (S106: YES), the information viewing server 110 decrypts the encryption cumulative release amount using the secret key sk and acquires the cleartext carbon footprint (S107). The information viewing server 110 displays the acquired carbon footprint value on a display or the like (S108).

In the above audit server process, not only the UID of the final product but also the UID of specific finished products manufactured in the middle of the supply chain SC can be set as the target ID. Therefore, for specific finished products, the cumulative carbon release amount registered by the reporters TRs, in other words, the carbon footprint value of the specific finished products, can be queried.

### Overview of First Embodiment

In the first embodiment described thus far, the encrypted different company release amount encrypted by the upstream transactor providing the delivery item and the encrypted own company release amount, which is the encrypted carbon release amount related to the process executed on the delivery item, are used in secure computation. Then, the encryption cumulative release amount, which is the result of the secure computation, is calculated, and this encryption cumulative release amount is provided as information to the downstream transactor to which the shipping item is supplied.

According to the above, even when the downstream transactor possesses the secret key sk, the encrypted different company release amount and the encrypted own company release amount, which were encrypted by the upstream transactor, are not provided to the downstream transactor. Therefore, the item-related information of the upstream transactor and the carbon release amount of the current transactor's own process are not disclosed to the downstream transactor. Additionally, as transactions progress, the encrypted own company release amount of each transactor TR is added to the encryption cumulative release amount. Therefore, the holder of the secret key sk can acquire the carbon footprint of the entire supply chain SC by decrypting the encrypted cumulative release amount. Thus, while keeping the information of individual transactors TR undisclosed, it becomes possible to acquire information about the entire supply chain SC.

Additionally, in the first embodiment, the pair of secret key skc and public key pkc and the pair of secret key skd and public key pkd are prepared by different transactors TR. Then, the reporter TRs (company C) holding the secret key skc provides the public key pkc to the upstream transactor (company B) and acquires the public key pkd from the downstream transactor (company D).

Furthermore, at the transactor terminal 50 of the reporter TRs, the clear text different company release amount obtained by decrypting the encrypted different company release amount using the secret key skc, is prepared. Then, the cleartext cumulative release amount, which is acquired through calculations using the cleartext different company release amount and the carbon release amount related to the process executed by the reporter TRs on the delivery items in their own process, is encrypted using the public key pkd and included in the information provided to the downstream transactor.

According to the above key operation, the transactors TR sharing a single public key pk are limited to only a part of the multiple transactors TR constituting the supply chain SC. Therefore, even when the secret key sk is leaked from the reporter TRs, the information that can be decrypted with the leaked secret key sk is limited to the information encrypted by a part of the transactors TR. As a result, it becomes possible to improve the security level against the leakage of the secret key sk.

Further, in the first embodiment, the supervisory authority SA of the supply chain SC holds a master secret key skM, which is different from the secret keys sk held by the transactors TR, on the information viewing server 110. The information viewing server 110 then decrypts the encryption cumulative release amount using the master secret key skM. Thus, by holding the master secret key skM on the information viewing server 110, it is possible to avoid a situation where decryption of the encryption cumulative release amount becomes impossible, even when the secret key sk is lost by the reporter TRs.

Furthermore, in the first embodiment, each transactor terminal 50 and the information management server 100s detect any unauthorized process through the secure computation. Therefore, even when the information is exchanged in the encrypted state, the amount of carbon release emitted during a process of each transactor TR can be correctly added to the encryption cumulative release amount. As a result, even when the information of individual transactors TR is not disclosed, it becomes possible to ensure the accuracy of the information for the entire supply chain SC.

Additionally, in the first embodiment, in the process of sharing the public key pk, the public key pk acquired from a subsequent transactor is provided to at least one upstream transactor. In this way, when the public key pk is handed over upstream in the supply chain SC, it becomes possible for transactors TR that do not have direct transactions with each other to share the public key pk while keeping their trading relationship confidential.

Further, in the first embodiment, the amount of carbon release associated with the delivery item is encrypted using the public key pk in the previous process and acquired as the encrypted different company release amount. In addition, the carbon release amount associated with the treatment performed on the delivery item in the own process is encrypted using the public key pk, and is set as the encrypted own company release amount. Then, by secure computation, the respective carbon release amounts are cumulated while still being encrypted to generate the encryption cumulative release amount. As described above, by using the secure computation to accumulate the carbon release amounts in the supply chain SC, it is possible to understand the carbon footprint of the final product without forcing the disclosure of information from each transactor TR. As a result, it becomes possible to lower the barriers to introducing a system for disclosing the carbon footprint.

Furthermore, in the first embodiment, the secret key sk and the public key pk based on fully homomorphic encryption are prepared. Therefore, in the secure computation, it becomes possible to perform addition, subtraction, multiplication, and division while keeping the data encrypted. As a result, it becomes possible to perform the secure computation corresponding to various processes executed by each transactor TR. According to the above, even when the connections between transactors TR are complex, it becomes possible to obtain the secure computation results with ensured accuracy.

In the above-described first embodiment, the key management unit 61 corresponds to a “key generation unit”, the information calculation unit 63 corresponds to an “information generation unit”, the processing circuits 50c and 100c correspond to a “computer”, and the supply chain management system corresponds to an “information management system”. Furthermore, the supervisory authority SA corresponds to a “supervisor”, the reporter TR corresponds to a “key holder”, the secret key Cskc corresponds to a “first secret key”, the public key Cpkc corresponds to a “first public key”, the secret key Dskd corresponds to a “second secret key”, and the public key Dpkd corresponds to a “second public key”. Furthermore, the encrypted different company release amount corresponds to the “acquisition encryption information”, the cleartext different company release amount corresponds to “acquisition cleartext information”, and the encrypted own company release amount corresponds to “generation encryption information”. Additionally, the encryption cumulative release amount corresponds to a “secure computation result” and an “encryption computation result”, the cleartext cumulative release amount corresponds to a “cleartext computation result”, and the carbon release amount corresponds to “emission amount information”.

### Second Embodiment

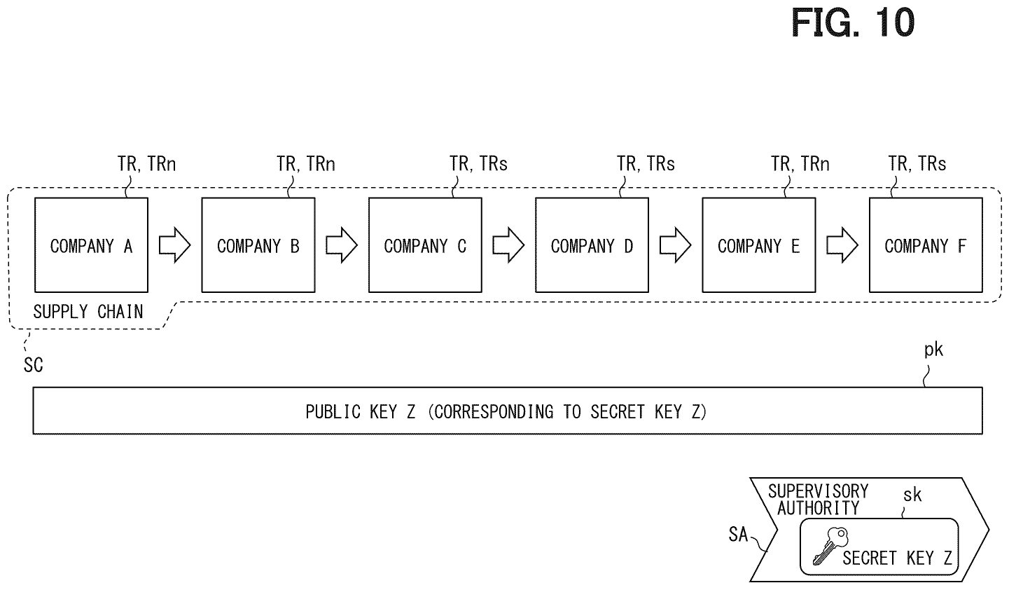

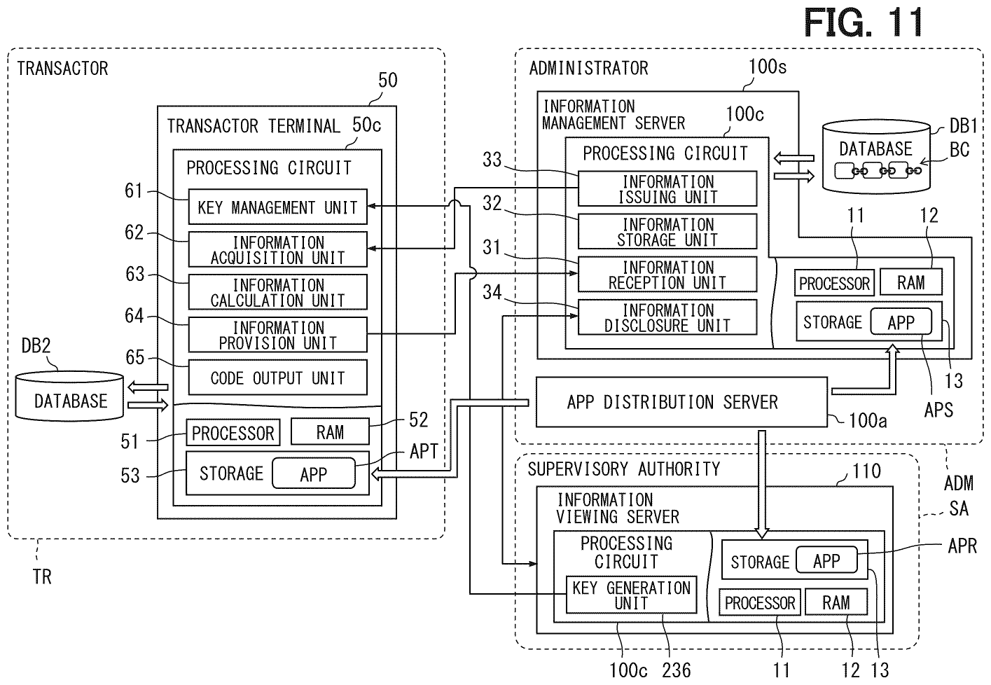

A second embodiment of the present disclosure shown in FIGS. 10 and 11 is a modification of the first embodiment. In the second embodiment, the generation of the secret key sk and the public key pk by the key management unit 61 of the transactor terminal 50 is not performed. On the other hand, the information viewing server 110 is equipped with a key generation unit 236 as a functional component based on the information viewing application APR.

The key generation unit 236 executes the key sharing process (see FIG. 3) instead of the key management unit 61, and generates the secret key sk and public key pk (FIG. 10, secret key Z, public key Z) based on fully homomorphic encryption (S11). The key generation unit 236 stores the generated secret key sk (S12). Furthermore, the key generation unit 236 identifies the transactor TR (see company F in FIG. 10) that supplies the final product in the supply chain SC as the recipient of the prepared public key pk (S13), and provides the public key pk to the transactor terminal 50 of the transactor TR (S14). Each transactor terminal 50 executes the key sharing process (see FIG. 4) to sequentially pass the public key pk to the upstream transactors TR in the supply chain SC. Through the cooperation of the key generation unit 236 and each key management unit 61, the public key pk designated by the supervisory authority SA is shared among the transactors TR (see companies A to F in FIG. 10).

Each transactor terminal 50 executes the secure computation process (see FIG. 5), adds the encrypted own company release amount corresponding to the carbon release amount in its own process to the encrypted different company release amount that was encrypted by the upstream transactor. As a result, at the transactor TR providing the final product, the encryption cumulative release amount, which includes the information on the carbon footprint of the final product, is calculated through the secure computation. The encryption cumulative release amount calculated at each transactor terminal 50 is registered in the administrator database DB1 of the information management server 100s in the second embodiment as well.

As a specific example, in the supply chain SC including the companies A to F, the carbon release amount acquired by the company A is encrypted with the public key pk and provided to the company B. Next, the carbon release amount acquired by the company B is encrypted with the public key pk, added to the encrypted carbon release amount (encrypted different company release amount) acquired from the company A, and provided to the company C. Furthermore, the carbon release amount acquired by the company C is also encrypted with the public key pk, added to the encrypted different company release amount (encryption cumulative release amount) acquired from the company B, and provided to the company D. Similarly, in the companies D to F, the carbon release amount is encrypted with the public key pk and added to the encryption cumulative release amount. As a result, the carbon footprint of the final product provided by the company F can be acquired.

The information viewing server 110 acquires the encryption cumulative release amount associated with the final product or the specific finished product from the information management server 100s through execution of the audit server process (see FIG. 9) (S105). The information viewing server 110 uses the secret key sk held by the key generation unit 236 to decrypt the acquired encryption cumulative release amount and acquire the carbon footprint (S107).

In the second embodiment described so far, similar effects to those of the first embodiment are achieved. Since the encrypted own company release amount is not provided to subsequent transactors, the carbon release amount of the own process is not disclosed to subsequent transactors. On the other hand, since the encrypted own company release amount of each transactor TR is added to the encryption cumulative release amount through the secure computation, the supervisory authority SA, which holds the secret key sk, can acquire the carbon footprint by decrypting the encryption cumulative release amount. Therefore, while keeping the information of individual transactors TR undisclosed, it becomes possible to acquire information for the entire supply chain SC.

Additionally, in the second embodiment, the secret key sk and the public key pk are prepared in the information viewing server 110 of the supervisory authority SA, and this public key pk is shared among each transactor TR. Then, on the information viewing server 110, the encryption cumulative release amount associated with the final product or the specific finished product is acquired, and the carbon footprint is acquired by decrypting the encryption cumulative release amount using the secret key sk. As described above, according to the operation where the secret key sk is managed on the information viewing server 110, it is possible to reduce the risk of leakage of the secret key sk. As a result, it is possible to implement a high-security supply chain management system.

In the above-described second embodiment, the final product and specific finished product correspond to a “supply item”, and the carbon footprint corresponds to a “decryption computation result”.

### Other Embodiments

Although multiple embodiments of the present disclosure have been described above, the present disclosure is not construed as being limited to the above-described embodiments, and can be applied to various embodiments and combinations within a range that does not depart from the spirit of the present disclosure.

In a first modification of the above embodiment, instead of the carbon release amount for each process, information on the amount of electricity or energy resources used in relation to the process executed on the item in each process is collected as the item-related information. Specifically, usage information indicating the amount of used electricity and energy resources is information for calculating the carbon release amount. The usage information for electricity is associated with type information indicating power generation methods, such as hydroelectric, thermal, wind, geothermal, nuclear, and solar power. Similarly, the usage information for energy resources is associated with information indicating the types of fuels, such as crude oil, coal, natural gas, and hydrogen.

In the secure computation process of the first modification (refer to FIG. 5), the acquisition encryption information is information obtained by encrypting, using the public key pk, the usage information for each type of electricity or energy resource associated with the delivery item (S42). Then, the usage information associated with the processes executed in the own process is encrypted using the public key pk for each type of electricity or energy resource (S49). Furthermore, the usage amount information for each type is cumulated while being encrypted by secure computation to generate the secure computation result (S50). This secure computation result is generated for each type of electricity or energy resource and constitutes the encrypted information of the values acquired by individually summing each usage information. The secure computation results for each type are uploaded to the information management server 100s as the information to be provided to the next process (S52).

In second and third modifications of the above-described embodiment, the information management method according to the present disclosure is applied to the accumulation of item-related information different from the carbon release amount. Specifically, in the second modification, the usage amounts of rare metals are accumulated for each type of rare metal. As a result, the secure computation results that can be decrypted into information indicating the total amount of rare metals used in the supply items can be acquired for each type of rare metal. In the third modification example, the emission amounts of specific hazardous substances, which are regulation targets, are accumulated for each type of hazardous substance. As a result, the secure computation results that can be decrypted into information indicating the total amount of hazardous substances generated by the manufacturing or distribution of the supply items can be acquired for each type of hazardous substance.

As described in the above first to third modifications, the information management method according to the present disclosure is particularly suitable for the accumulation of information that is legally required to be recorded. The item-related information to be recorded is not limited to the above-described carbon release amount, and may be modified as appropriate.

In a fourth modification of the above first embodiment, the information viewing server 110 does not hold the master secret key skM. The information viewing server 110 receives the provision of the secret key sk from each reporter TRs. Even with such key management, the information viewing server 110 is able to acquire information on the entire supply chain SC. It is preferable that the secret key sk is provided directly to the information viewing server 110 without being relayed through the information management server 100s.

In the above embodiment, the detection of unauthorized process in secure computation was performed at each of the transactor terminals 50 and the information management server 100s. However, the detection of unauthorized process may be implemented only in some configurations. For example, in a fifth modification, while the detection of unauthorized process is performed by each transactor terminal 50, the detection of unauthorized process by the information management server 100s is omitted. Additionally, in a sixth modification, while the detection of unauthorized process is executed by the information management server 100s, the detection of unauthorized process by each transactor terminal 50 is omitted.

Furthermore, in a seventh modification, the detection of unauthorized process is performed only by some of the transactor terminals 50. Specifically, the detection of unauthorized process is performed by the transactor terminals 50 of the reporters TRs, while it is not performed by the transactor terminal 50 of the non-reporter TRn. Additionally, in an eighth modification, instead of verifying the secure computation of the own process, it is confirmed whether any unauthorized process has been executed on the secure computation of the previous process.

In the above embodiments, the administrator ADM and the supervisory authority SA exist as separate entities. On the other hand, in a ninth modification of the above embodiment, the supervisory authority SA also serves as the administrator ADM. In such ninth modification, the functionality of the processing circuit 100c may be integrated into the information viewing server 110.

In the above embodiment, server devices were used as the information management server 100s and the information viewing server 110. However, similar to the transactor terminal 50, devices such as smartphones, tablet terminals, and personal computers may also be used as the information management server 100s or the information viewing server 110.

In a tenth modification of the above embodiment, the attachment of UID or hash values to items is achieved using RFID (radio frequency identifier) technology. In such tenth modification, RFID tags are used on the data storage medium instead of paper media with printed two-dimensional codes. According to the use of such RFID technology, it becomes possible to remotely read UIDs and the like even when the RFID tag is not directly visible. In the tenth modification, instead of a code reader or camera, a reader capable of reading RFID tags is connected to the transactor terminal 50 either via a wired or wireless connection.

In the above embodiment, the functions provided by the information management server 100s and the information viewing server 110 can be provided by software and the hardware executing it, software alone, hardware alone, or a combination of these. Similarly, the functions provided by the transactor terminal 50 can also be provided by software and the hardware executing it, software alone, hardware alone, or a combination of these. When such a function is provided by an electronic circuit as hardware, each function can also be provided by a digital circuit including a large number of logic circuits or an analog circuit. Additionally, the software for implementing such functions may include, at least in part, code that is automatically generated by a neural network trained using training data or language model.

Each processor 11, 51 in the above-described embodiments may include at least one calculation core such as a CPU (Central Processing Unit) and a GPU (Graphics Processing Unit). The processor may further include a field-programmable gate array (FPGA) and an IP core having other dedicated functions.

The form of the storage medium employed as each storage in the above embodiment, which stores the programs related to the implementation of the information management method of the present disclosure, may be modified as appropriate. For example, the storage medium is not limited to the configuration provided on the circuit board, and may be provided in the form of a memory card or the like. The storage medium may be inserted into a slot portion, and electrically connected to a computer bus. Furthermore, the storage medium may be an optical disk, a hard disk drive, a solid-state drive, or other mediums used as the source or distribution medium for copying programs to a computer.

The controller and the method thereof described in the present disclosure may be implemented by a dedicated computer, which includes a processor programmed to execute one or more functions performed by computer programs. Alternatively, the device and the method thereof according to the present disclosure may be implemented by a dedicated hardware logic circuit. Alternatively, the device and the method thereof according to the present disclosure may be implemented by at least one dedicated computer implemented by a combination of a processor that executes a computer program and at least one hardware logic circuit. The computer program may also be stored on a computer-readable and non-transitory tangible storage medium as an instruction executed by a computer.

What is claimed is:

1. An information management method implemented by a computer for managing information associated with each of a plurality of transactors constituting a supply chain, the method comprising
preparing a secret key and a public key based on homomorphic encryption;
sharing the public key by the plurality of transactors;
acquiring acquisition encryption information encrypted using the public key by an upstream transactor that is a transactor in a previous process that supplies a delivery item;
preparing generation encryption information obtained by encrypting, using the public key, item-related information related to a process executed on the delivery item; and
setting a secure computation result to provision information provided to a downstream transactor that is a transactor in a next process that provides a shipping item, wherein the secure computation result is obtained by secure computation using the acquisition encryption information and the generation encryption information.

2. The information management method according to claim 1, wherein
the sharing the public key further includes:
preparing by a different a transactor, as the secret key and the public key, a first secret key and a first public key and a second secret key and a second public key;
providing by a key holder that is a transactor that holds the first secret key, the first public key to the upstream transactor, and acquiring the second public key from the downstream transactor;
by the key holder, preparing acquisition clear text information obtained by decrypting the acquisition encryption information using the first secret key;
encrypting, using the second public key, a clear text computation result obtained by a computation using the acquisition clear text information and the item-related information related to a process executed by the key holder on the delivery item; and
adding an encryption computation result that has been encrypted to the provision information.

3. The information management method according to claim 2, further comprising:
by a supervisor supervising the supply chain, decrypting the secure computation result using a master secret key different from the secret key held by the transactor.

4. The information management method according to claim 1, wherein
the sharing the public key further includes:
preparing the secret key and the public key by a supervisor that supervises the supply chain;
by the supervisor, acquiring the secure computation result associated with a supply item supplied by the supply chain; and
acquiring a decryption computation result obtained by decrypting the secure computation using the secret key.

5. The information management method according to claim 1, further comprising
detecting that an unauthorized process has been executed in the secure computation.

6. The information management method according to claim 1, wherein
the sharing the public key includes providing the public key acquired from the downstream transactor to at least one of the upstream transactor.

7. The information management method according to claim 1, wherein
the acquiring the acquisition encryption information includes acquiring the acquisition encryption information obtained by encrypting, using the public key, emission amount information of greenhouse gas associated with the delivery item,
the preparing the generation encryption information includes encrypting, using the public key, the emission amount information associated with the process executed on the delivery item, and
the method further includes, in order to obtain the secure computation, setting, to the provision information, the secure computation result obtained by cumulating the emission amount information that has been encrypted by the secure computation.

8. The information management method according to claim 1, wherein
the acquiring the acquisition encryption information includes acquiring the acquisition encryption information obtained by encrypting, using the public key, usage amount information for each type of electric power or an energy resource associated with delivery item,
the preparing the generation encryption information includes encrypting for each type, using the public key, the usage amount information associated with the process executed on the delivery item, and
the method further includes, in order to obtain the secure computation, setting, to the provision information, the secure computation result obtained by cumulating the usage amount information of each type, the usage amount information having been encrypted by the secure computation.

9. The information management method according to claim 1, wherein
the sharing the public key includes preparing the secret key and the public key based on fully homomorphic encryption.

10. An information management system for managing information associated with each of a plurality of transactors constituting a supply chain, the system comprising:
a key generation unit configured to
prepare a secret key and a public key based on homomorphic encryption, and
cause the plurality of transactors to share the public key;
an information acquisition unit configured to acquire acquisition encryption information encrypted using the public key by an upstream transactor that is a transactor in a previous process that supplies a delivery item;
an information generation unit configured to prepare generation encryption information obtained by encrypting, using the public key, item-related information related to a process executed on the delivery item; and
an information provision unit configured to set a secure computation result to provision information provided to a downstream transactor that is a transactor in a next process that provides a shipping item, wherein the secure computation result is obtained by secure computation using the acquisition encryption information and the generation encryption information.

11. An information management system for managing information associated with each of a plurality of transactors constituting a supply chain, the system comprising:
a processor; and
a memory coupled to the processor and storing program instructions that when executed by the processor cause the processor to at least:
prepare a secret key and a public key based on homomorphic encryption, and
cause the plurality of transactors to share the public key;
acquire acquisition encryption information encrypted using the public key by an upstream transactor that is a transactor in a previous process that supplies a delivery item;
prepare generation encryption information obtained by encrypting, using the public key, item-related information related to a process executed on the delivery item; and
set a secure computation result to provision information provided to a downstream transactor that is a transactor in a next process that provides a shipping item, wherein the secure computation result is obtained by secure computation using the acquisition encryption information and the generation encryption information.
